(19) United States
(12) Patent Application Publication
(10) Pub. No.: US 2020/0058038 A1
(43) Pub. Date: Feb. 20, 2020

(54) VENUE MONITORING THROUGH SENTIMENT ANALYSIS

(71) Applicant: XINOVA, LLC, Seattle, WA (US)

(72) Inventor: Noam HADAS, Tel-Aviv (IL)

(73) Assignee: XINOVA, LLC, Seattle, WA (US)

(21) Appl. No.: 16/345,671

(22) PCT Filed: Oct. 31, 2016
(86) PCT No.: PCT/US16/59690

§ 371 Date: Apr. 26, 2019

(51) Int. Cl. G06Q 30/02; G06K 9/00

(52) U.S. Cl. CPC G06Q 30/0201; G06K 9/00302; G06K 9/00778; G06K 9/00335

(57) ABSTRACT

Technologies are generally described for methods and systems effective to generate an alert through sentiment analysis. In some examples, a device may receive initial image data, where the initial image data may be associated with an initial image. The device may further detect sentiment values in the initial image data, where the sentiment values may correspond to two or more locations in the initial image. The device may further compare respective sentiment values with an sentiment threshold in order to identify region data in the initial image data that satisfies the sentiment threshold. The device may further generate the alert based on the identification of the first region data.

### BACKGROUND

Unless otherwise indicated herein, the materials described in this section are not prior art to the claims in this application and are not admitted to be prior art by inclusion in this section.

An image may include one or more faces with corresponding expressions. In some examples, expression analysis may be used to evaluate expressions of these faces. The expression analysis may, for example, assign a number to a particular facial expression.

### SUMMARY

In some examples, methods to generate an alert through sentiment analysis are generally described. The methods may include receiving, by a device, initial image data associated with an initial image. The methods may further include detecting sentiment values in the initial image data. The sentiment values may correspond to two or more locations in the initial image. The methods may further include comparing, by the device, the respective sentiment values with an sentiment threshold, to identify region data in the initial image data that satisfies the sentiment threshold. The methods may further include generating, by the device, the alert based on the identification of the region data.

In some examples, systems effective to generate an alert through sentiment analysis are generally described. The systems may include an image device that may be effective to capture initial image data. The systems may further include a processor configured to be in communication with the image device. The systems may further include a sentiment module configured to be in communication with the processor. The systems may further include an alert generation module configured to be in communication with the processor and the sentiment module. The processor may be configured to receive initial image data from the image device. The initial image data may be associated with an initial image. The processor may be further configured to send the initial image data to the sentiment module. The sentiment module may be configured to detect sentiment values in the initial image data. The sentiment values may correspond to two or more locations in the initial image. The alert generation module may be configured to compare respective sentiment values with a sentiment threshold to identify first region data in the initial image data that satisfies the sentiment threshold. The alert generation module may be further configured to generate the alert based on the identification of the region data.

In some examples, devices effective to generate an alert through sentiment analysis are generally described. The devices may include a memory configured to store an instruction and a sentiment threshold. The devices may further include a sentiment module configured to be in communication with the memory. The devices may further include an alert generation module configured to be in communication with the sentiment module and the memory. The sentiment module may be configured to receive initial image data associated with an initial image. The sentiment module may be further configured to detect sentiment values in the initial image data. The sentiment values may correspond to two or more locations in the initial image. The sentiment module may be further configured to store the respective sentiment values in the memory. The alert generation module may be configured to compare respective sentiment values with the sentiment threshold to identify region data in the initial image data that satisfies the sentiment threshold. The alert generation module may be further configured to generate the alert based on the identification of the first region data.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example system that can be utilized to implement venue monitoring through sentiment analysis;

FIG. 2A illustrates the example system of FIG. 1 with additional detail relating to identification of region data;

FIG. 2B illustrates the example system of FIG. 1 with additional detail relating to identification of region data;

FIG. 2C illustrates the example system of FIG. 1 with additional detail relating to identification of region data;

FIG. 3A illustrates the example system of FIG. 1 with additional detail relating to identification of region data;

FIG. 3B illustrates the example system of FIG. 1 with additional detail relating to identification of region data;

FIG. 4 illustrates the example system of FIG. 1 with additional detail relating to a user interface;

FIG. 5 illustrates a flow diagram for an example process to implement venue monitoring through sentiment analysis;

FIG. 6 illustrates an example computer program product that can be utilized to implement venue monitoring through sentiment analysis; and

FIG. 7 is a block diagram illustrating an example computing device that is arranged to implement venue monitoring through sentiment analysis, all arranged according to at least some embodiments described herein.

### DETAILED DESCRIPTION

In the following detailed description, reference is made to the accompanying drawings, which form a part hereof In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

Briefly stated, technologies are generally described for methods and systems effective to generate an alert in response to monitoring a venue through sentiment analysis. In some examples, a device may receive initial image data, where the initial image data may be associated with an initial image, such as an image of a crowd in the venue. The device may further identify sentiment values in the initial image data, where the sentiment values may correspond to two or more faces or locations in the initial image. Each face in the initial image may correspond to a person present in the venue. For example, each face in the initial image may correspond to a respective sentiment value, and each sentiment value may be effective to indicate a sentiment such as happy, sad, neutral, angry, etc. The device may further compare the respective sentiment values with a sentiment threshold in order to identify first region data in the initial image data that satisfies the sentiment threshold, and to identify second region data in the initial image data that does not satisfy the sentiment threshold. For example, the identified first region data may correspond to a first region in the initial image, where the first region may include one or more faces with sentiment values that satisfy the threshold. The first region in the initial image may, for example, include angry faces. For example, the identified second region data may correspond to a second region in the initial image, where the second region may include one or more faces that are not angry. The device may further generate the alert based on the identification of the first region data.

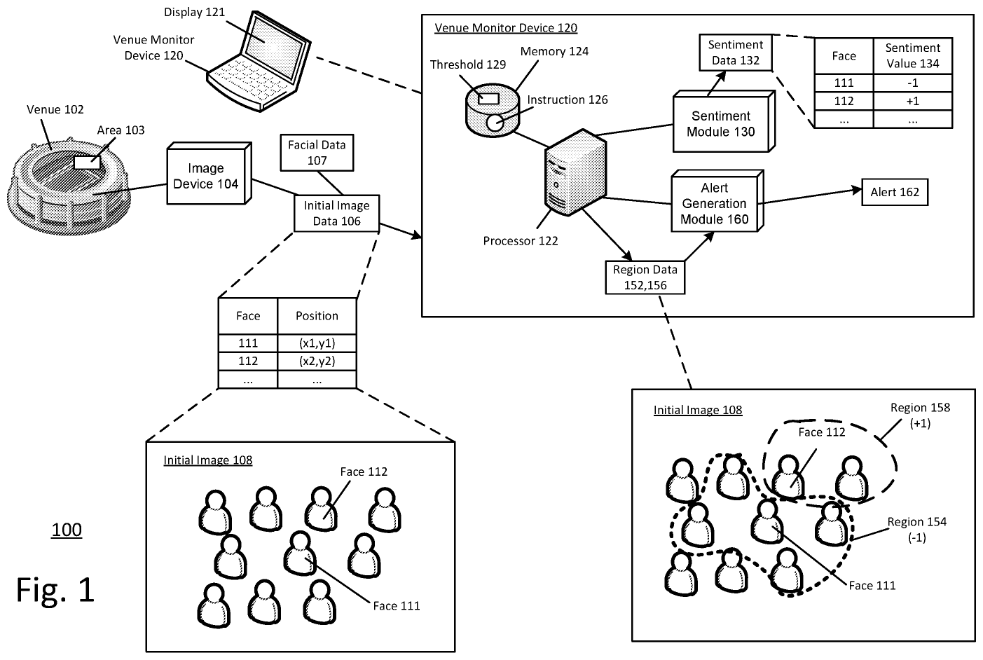

FIG. 1 illustrates an example system 100 that can be utilized to implement venue monitoring through sentiment analysis, arranged in accordance with at least some embodiments described herein. System 100 may be implemented with a venue monitor device 120 and/or one or more image devices, such as an image device 104. In some examples, venue monitor device 120 may be a desktop computer, a laptop computer, a tablet computer, a cellular phone, etc. In some examples, image device 104 may be a camera, a video recorder, etc. One or more image devices, such as image device 104, may be located in a venue 102, where venue 102 may be a location such as a park, a street, a shopping mall, or may be a location in which an event may occur, such as a stadium, an arena, a concert hall, an amusement park, a theme park, etc. Venue monitor device 120 may be configured to be in communication with the one or more image devices located in venue 102, including image device 104. In some examples, venue monitor device 120 may be configured to be in communication with image device 104 through the Internet, a cellular network, a wireless local area network, a local area network, etc.

In the example shown in FIG. 1, image device 104 may generate initial image data 106, where initial image data 106 may be associated with an initial image 108. Initial image data 106, when rendered on a display, such as a display 121 of venue monitor device 120, may produce initial image 108 on display 121. In some examples, initial image 108 may be an image of an area 103 of venue 102, where area 103 may be a part of venue 102 in three-dimensional space. For example, if venue 102 is a stadium, area 103 may be a part of venue 102 including particular sections and rows of seats. In another example, if venue 102 is a shopping mall, area 103 may be a particular section of the shopping mall including particular shops. Initial image 108 may include locations that, in turn, include two or more faces, such as a face 111 and a face 112, where each face may correspond to a respective person present in venue 102. Initial image data 106 may include facial data 107, where facial data 107 may correspond to each face, such as faces 111, 112, shown in initial image 108. In some examples, facial data 107 may include data associated with attributes of respective faces, such as color, intensity, brightness, etc. In some examples, initial image data 106 may further include respective positions of faces 111, 112 in initial image 108.

Venue monitor device 120 may include a processor 122, a memory 124, a sentiment module 130, and/or an alert generation module 160. Processor 122, memory 124, sentiment module 130, and/or alert generation module 160 may be configured to be in communication with each other. Memory 124 may be configured to store an instruction 126, where instruction 126 may include a threshold 129. Instruction 126 may include instructions effective to implement operations of processor 122, sentiment module 130, and/or alert generation module 160. In some examples, instruction 126 may also be stored in sentiment module 130, and/or alert generation module 160. In some examples, instruction 126 may include instructions relating to image processing techniques, voice classification techniques, motion detection techniques, facial expression analysis techniques, etc. to facilitate determination of sentiment values 134 and generation of sentiment data 132.

In some examples, sentiment module 130, and/or alert generation module 160 may each be a hardware component of processor 122. In some examples, sentiment module 130, and/or alert generation module 160 may be a component distinct from processor 122. In some examples, sentiment module 130, and/or alert generation module 160 may each be an electronic component, such as an integrated circuit, an embedded system, etc., of processor 122. In some examples, sentiment module 130, and/or alert generation module 160 may each be software modules that may be implemented with processor 122. In some examples, processor 122 may be configured to control operations of sentiment module 130, and/or alert generation module 160.

As will be described in more detail below, venue monitor device 120 may generate sentiment data 132, where sentiment data 132 may include respective sentiment values 134 for respective facial data 107 of initial image data 106. In some examples, sentiment data 132 may include a function of sentiment values 134. Sentiment values 134 may be effective to indicate an expression of a respective face, where examples of expressions may include happy, sad, neutral, angry, etc. Venue monitor device 120 may compare respective sentiment values 134, or a function of sentiment values 134, with a threshold in order to identify region data 152 of initial image data 106, where region data 152 may correspond to a region 154 within initial image 108. Region 154 in initial image 108 may include one or more faces, where the one or more faces in region 154 may correspond to sentiment values 134 that satisfies threshold 129. In response to identifying region data 152 that corresponds to region 154, venue monitor device 120 may generate an alert 162.

Continuing with the example shown in FIG. 1, processor 122 of venue monitor device 120 may receive initial image data 106 from image device 104 and, in response, may store initial image data 106 in memory 124. Processor 122, in response to receiving initial image data 106, may further send initial image data 106 to sentiment module 130. Sentiment module 130 may execute instruction 126 to determine respective sentiment values 134 of respective facial data 107 (the determination will be described in more detail below). Sentiment values 134 may be integers, where each integer may represent a sentiment. For example, a sentiment value 134 of face 111 may be “−1” when face 111 appears to show an angry sentiment. A sentiment value 134 of face 111 may be “−2” when face 111 appears to show a furious sentiment. A sentiment value 134 of face 111 may be “−3” when face 111 appears to show a raging sentiment. A sentiment value 134 of face 111 may be “0” when face 111 appears to show a neutral sentiment. A sentiment value 134 of face 111 may be “1” when face 111 appears to show a happy sentiment. A sentiment value 134 of face 111 may be “2” when face 111 appears to show a cheerful sentiment. A sentiment value 134 of face 111 may be “3” when face 111 appears to show an excited sentiment. In response to determining sentiment values 134, sentiment module 130 may generate sentiment data 132, where sentiment data 132 may include indications of faces 111, 112 of initial image 108 and corresponding sentiment values 134. Sentiment data 132 may be effective to indicate correspondences between faces of initial image 108 and corresponding sentiment values 134. Sentiment module 130 may store sentiment data 132 in memory 124. Sentiment module 130 may further send sentiment data 132 to processor 122, and/or alert generation module 160.

Processor 122 may receive sentiment data 132 and, in response, may identify region data 152 in initial image data 106 based on sentiment data 132 and initial image data 106. Processor 122 may compare sentiment values 134 in sentiment data 132 with threshold 129 to determine whether respective sentiment value 134 satisfies threshold 129. In an example, processor 122 may be configured to identify one or more faces in sentiment data 132 where corresponding sentiment values 134 of the identified faces satisfies threshold 129 (the identification will be described in more detail below). Processor 122 may identify region data 152 in initial image data 106 based on the identified faces. Processor 122 may further identify one or more faces in sentiment data 132 where corresponding sentiment values 134 of the identified faces do not satisfy threshold 129. Processor 122 may identify region data 156 in initial image data 106 based on the identified faces, with corresponding sentiment values 134, that do not satisfy threshold 129. Region data 156 may be associated with a region 158, where region data 156 may be different from region data 152, and region 158 may be different from region 154. Processor 122 may store region data 152, 156 in memory 124 and may send region data 152 to alert generation module 160.

Alert generation module 160 may receive region data 152, 156 and, in response, may analyze region data 152, 156 to determine whether to generate an alert 162. In some examples, processor 122 may send a signal to alert generation module 160 to inform alert generation module 160 that region data 152 includes sentiment values 134 that satisfies threshold 129. Alert generation module 160 may retrieve region data 152 from memory 124, or receive region data 152 from processor 122, in response to receiving the signal from processor 122. Alert generation module 160 may execute instruction 126 to analyze region data 152, 156. Alert generation module 160 may analyze a size, shape, rate of change, etc., of region data 152, 156, in order to determine whether to generate alert 162. Alert 162 may be an alert effective to indicate a potential presence of a threat associated with venue 102.

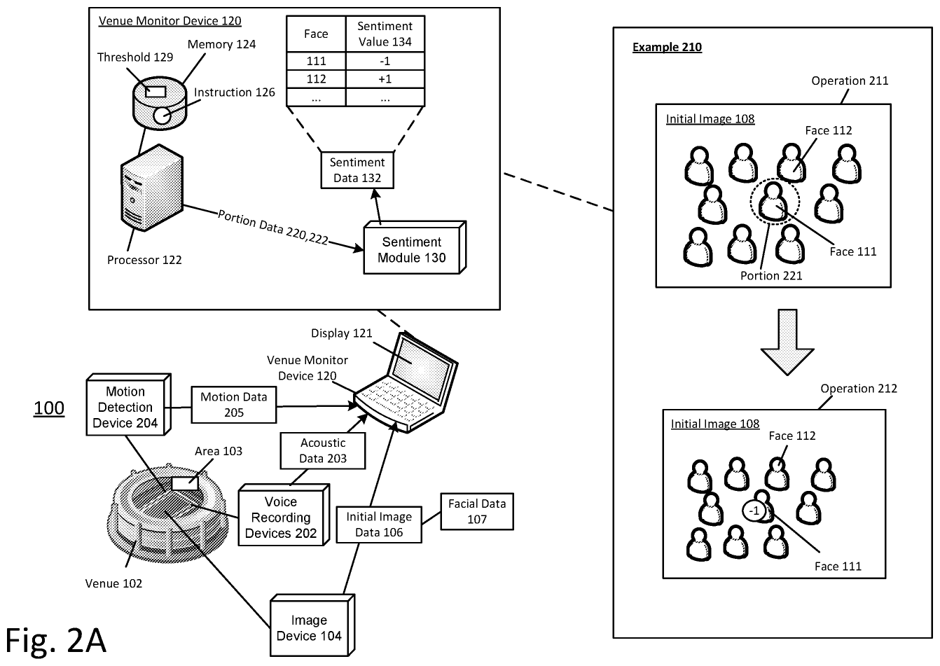

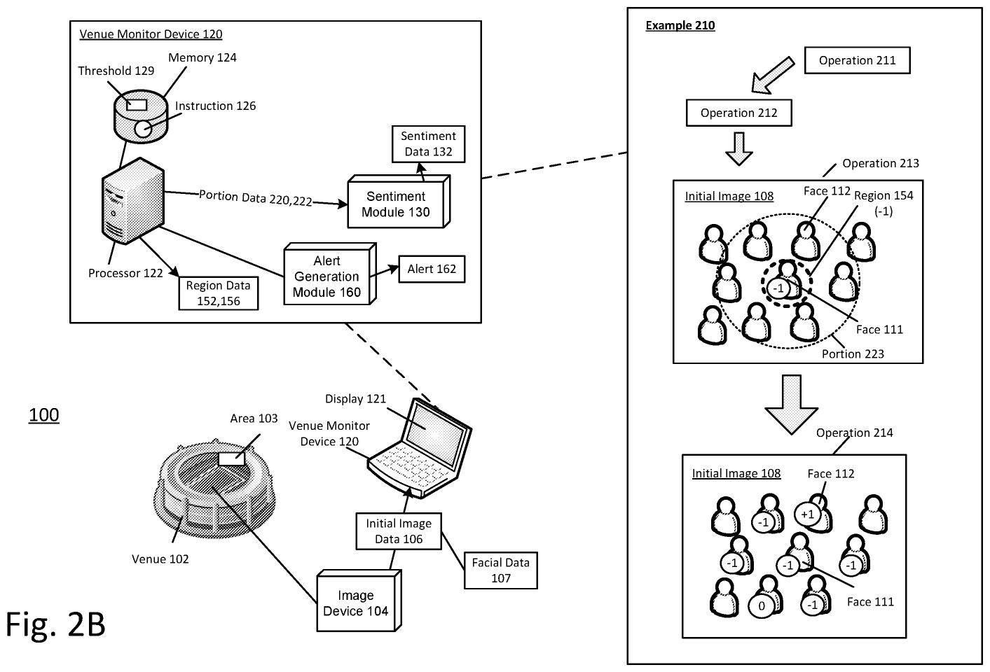

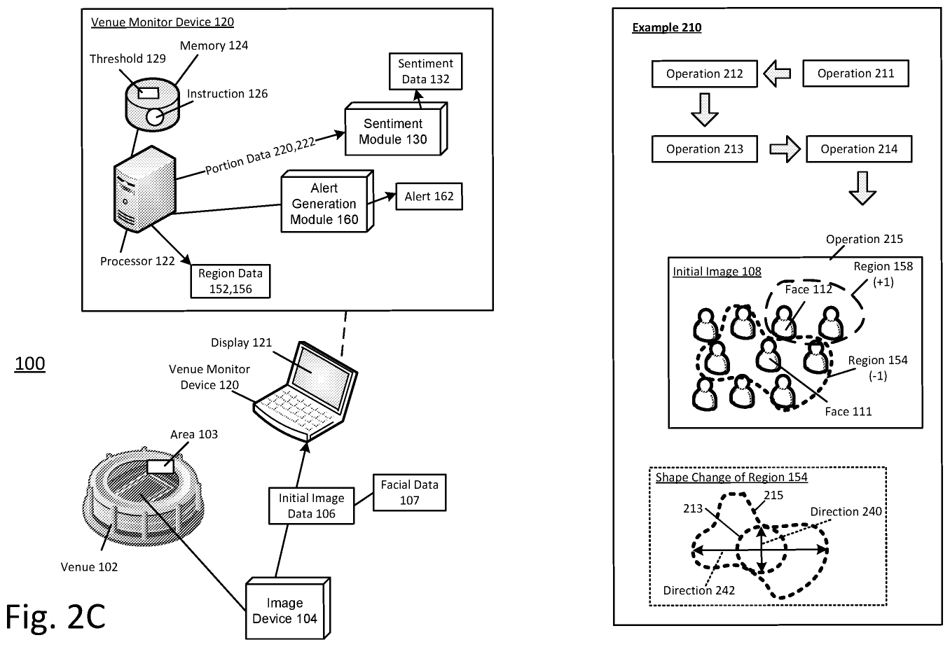

FIG. 2A illustrates example system 100 of FIG. 1 with additional detail relating to identification of region data, arranged in accordance with at least some embodiments described herein. FIG. 2A is substantially similar to system 100 of FIG. 1, with additional details. Those components in FIG. 2A that are labeled identically to components of FIG. 1 will not be described again for the purposes of clarity.

In an example 210 shown in FIG. 2, venue monitor device 120 may identify region data 152 by performing operations 211, 212, 213, 214, and/or 215. At operation 211, processor 122 of venue monitor device 120 may select portion data 220 from initial image data 106, where portion data 220 may correspond to a portion 221 in initial image 108. Portion 221 in initial image 108 may include one or more faces, such as face 111. Processor 122 may select portion data 220 in initial image data 106 based on instruction 126. For example, instruction 126 may include instructions for processor 122 to select a portion of initial image 108 centered at a center of initial image 108. In another example, instruction 126 may include instructions for processor 122 to select a portion of initial image 108 centered at a random position in initial image 108. In another example, instruction 126 may include instruction for processor 122 to select a portion of initial image 108 by scanning initial image 108 until a presence of at least one face is detected. Instruction 126 may further include an indication of a size and/or a shape of portion 221, such that processor 122 may select portion data 220 based on the size and/or shape of portion 221 indicated by instruction 126. For example, instruction 126 may indicate that portion 221 should be a circle of a radius of “1 unit”, such that processor 122 may identify portion data 220 that corresponds to a circle with a radius of “1 unit”. In response to selecting portion data 220 in initial image data 106, processor 122 may send portion data 220 to sentiment module 130.

Example 210 may continue from operation 211 to operation 212. At operation 212, sentiment module 130 may receive portion data 220 and, in response, may determine sentiment values 134 for respective faces in portion 221. Sentiment module 130 may determine sentiment values 134 by applying instruction 126 on facial data 107. For example, sentiment module 130 may identify face 111 in facial data 107 and, in response, may determine sentiment value 134 for face 111. In an example where instruction 126 includes instructions relating to facial expression analysis techniques, sentiment module 130 may determine sentiment value 134 of faces in portion 221 based on attributes of a face such as color, intensity, shape, contrast, head position, eye position and eye state (open/closed/semi-open), nose state (relaxed or flared nostrils), mouth state (open, closed, curled up or down, etc.), eyebrows state (relaxed, raised, contracted, etc.) pose, etc.

In an example, instruction 126 may include instructions relating to voice classification techniques. In the example, sentiment module 130 may determine sentiment value 134 of faces in portion 221 based on acoustic data 203 received from image device 104 and/or one or more voice recording devices 202, where voice recording devices 202 may be located in venue 102. In some examples, voice recording devices 202 may be part of image device 104. Voice recording device 202 may be configured to collect sound waves from area 103 of venue 102 and, in response, may transform the collected sound waves into acoustic data 203. Sentiment module 130 may determine sentiment value 134 of faces in portion 221 based on an application of voice classification techniques in instruction 126 on acoustic data 203.

In an example where instruction 126 includes instructions relating to motion detection techniques, sentiment module 130 may determine sentiment value 134 of faces in portion 221 based on motion data 205 received from image device 104 and/or one or more motion detection devices 204, where motion detection devices 204 may be located in venue 102. In some examples, motion detection devices 204 may be part of image device 104. Motion detection devices 204 may be configured to detect motions of faces in portion 221, and transform the detected motion into motion data 205. For example, a particular person associated with face 111 in initial image 108 may be moving his arms at a relatively fast rate. Motion detection devices 204 may record the movement of the arms of the particular person, such as by recording positions of a hand of the particular person at a particular time interval. Motion detection device 204 may transform the recorded position of the hand at the particular time interval into motion data 205. Sentiment module 130 may determine sentiment value 134 of faces in portion 221 based on an application of the motion detection techniques in instruction 126 on motion data 205.

Continuing operation 212, sentiment module 130 may apply instruction 126 on facial data 107 to determine sentiment value 134. Based on instruction 126, sentiment module 130 may determine that face 111 appears to show an angry sentiment, and determine a sentiment value 134 of “−1” for face 111. Sentiment module 130 may generate and/or update sentiment data 132 such that sentiment data 132 includes correspondence between face 111 and a sentiment value 134 of “4”. Upon a completion of determining sentiment value 134 for faces in portion 221, sentiment module 130 may send a completion signal to processor 122 to notify processor 122 that determination of sentiment values 134 of faces in portion 221 is completed. Sentiment module 130 may store sentiment data 132 in memory 124.

FIG. 2B illustrates example system 100 of FIG. 1 with additional detail relating to identification of region data, arranged in accordance with at least some embodiments described herein. FIG. 2B is substantially similar to system 100 of FIGS. 1-2A, with additional details. Those components in FIG. 2B that are labeled identically to components of FIG. 1-2A will not be described again for the purposes of clarity.

Example 210 may continue from operation 212 to operation 213. At operation 213, processor 122 may retrieve sentiment data 132 from memory 124 or may receive sentiment data 132 from sentiment module 130. Processor 122 may compare sentiment values 134 in sentiment data 132 with threshold 129 to identify one or more faces. In some examples, instruction 126 may indicate a condition for a particular sentiment value 134 to satisfy threshold 129. For example, instruction 126 may indicate whether a particular sentiment value 134 may satisfy threshold 129 if the particular sentiment value 134 is greater than, less than, or within a range of threshold 129. In example 210, threshold 129 may be “0”, and instruction 126 may indicate that a particular sentiment value 134 may satisfy threshold 129 if the particular sentiment value 134 is less than threshold 129. Processor 122 may identify one or more faces that correspond to sentiment values 134 that are less than “0”. For example, upon a comparison of sentiment value 134 of face 111 with threshold 129, processor 122 may identify face 111 in response to sentiment value 134 “−1” of face 111 being less than threshold 129 of “0”.

Continuing operation 213, upon a completion of identifying faces in sentiment data 132, processor 122 may identify region data 152 in initial image data 106, where region data 152 may correspond to region 154 in initial image 108. In an example, in response to identifying face 111, processor 122 may identify a position of face 111 in initial image data 106 and may identify region data 152 based on the position of face 111. In response to identifying region data 152, processor 122 may send region data 152 to alert generation module 160. Alert generation module 160 may receive region data 152 and, in response, may determine whether to generate alert 162 based on one or more conditions indicated by instruction 126. In an example, instruction 126 may include a condition to indicate that alert generation module 160 should generate alert 162 when a particular number of faces corresponding to sentiment values 134 that satisfy threshold 129 are present in region 154. In another example, instruction 126 may include a condition to indicate that alert generation module 160 should generate alert 162 when region 154 is of a particular size. In another example, instruction 126 may include a condition to indicate that alert generation module 160 should generate alert 162 when a rate of change of region 154 exceeds a particular rate. In another example, instruction 126 may include a condition to indicate that alert generation module 160 should generate alert 162 when particular number of faces corresponding to sentiment values 134 that satisfy threshold 129 are present in region 154, and maintain their sentiments for more than a predetermined period of time.

Continuing operation 213, in example 210, instruction 126 may indicate that alert generation module 160 should generate alert 162 when five faces corresponding to sentiment values 134 that satisfies threshold 129 are present in region 154. Since region 154 includes one face (face 111) that corresponds to an sentiment value 134 that satisfies threshold 129, alert generation module 160 may not generate alert 162. Alert generation module 160 may send a signal to processor 122 to request processor 122 to identify more faces and/or additional region data in initial image data 106. Instruction 126 may further include instructions for processor 122 to identify portion data different from portion data 220. For example, instruction 126 may indicate that processor 122 may expand a radius of portion 221 by a particular size, such as by “1 unit”, in order to identify a portion 223 of initial image 108, where portion 223 may be larger than portion 221 and may include more faces than portion 221. Based on instruction 126, processor 122 may identify portion data 222 associated with portion 223. In response to identifying portion data 222, processor 122 may send portion data 222 to sentiment module 130 to determine sentiment values 134 of faces in portion data 222.

Example 210 may continue from operation 213 to operation 214. At operation 214, sentiment module 130 may receive portion data 222 and, in response, may determine sentiment values 134 for respective faces in portion 223. Sentiment module 130 may apply instruction 126 on facial data 107 to determine sentiment values 134. Based on instruction 126, sentiment module 130 may determine that face 112 appears to show a happy sentiment, and determine a sentiment value 134 of “+1” for face 112. Sentiment module 130 may generate and/or update sentiment data 132 such that sentiment data 132 includes correspondence between face 112 and a sentiment value 134 of “+1”. Sentiment module 130 may continue to determine sentiment values 134 for faces within portion 223 and update sentiment data 132. Upon a completion of determining sentiment value 134 for faces in portion 223, sentiment module 130 may send a completion signal to processor 122 to notify processor 122 that determination of sentiment values 134 of faces in portion 223 is completed. Sentiment module 130 may update sentiment data 132 and may store sentiment data 132 in memory 124.

FIG. 2C illustrates example system 100 of FIG. 1 with additional detail relating to identification of region data, arranged in accordance with at least some embodiments described herein. FIG. 2C is substantially similar to system 100 of FIGS. 1-2B, with additional details. Those components in FIG. 2C that are labeled identically to components of FIG. 1-2B will not be described again for the purposes of clarity.

Example 210 may continue from operation 214 to operation 215. At operation 215, processor 122 may retrieve sentiment data 132 from memory 124 or may receive sentiment data 132 from sentiment module 130. Processor 122 may compare sentiment values 134 in sentiment data 132 with threshold 129 to identify one or more faces. Processor 122 may identify one or more faces that correspond to sentiment values 134 that are less than a threshold such as “0”. Upon a completion of identifying faces in sentiment data 132, processor 122 may identify region data 152 in initial image data 106, where region data 152 may correspond to region 154 in initial image 108. In response to identifying region data 152, processor 122 may send region data 152 to alert generation module 160. Alert generation module 160 may receive region data 152 and, in response, may determine whether to generate alert 162 based on one or more conditions indicated by instruction 126. Instruction 126 may indicate that alert generation module 160 should generate alert 162 when five faces corresponding to sentiment values 134 that satisfy threshold 129 are present in region 154. Since region 154 includes five faces that corresponds to sentiment values 134 that satisfy threshold 129, alert generation module 160 may generate alert 162. Processor 122 may further identify regions that include faces that correspond to sentiment values 134 that fail to satisfy threshold 129. For example, processor 122 may identify region data 156 associated with region 158, where region 158 include faces that corresponds to sentiment values 134 that fail to satisfy threshold 129. In some examples, the number of faces in region 154 being greater than the number of faces indicated by instruction 126 may indicate a potential presence of a threat in area 103 of venue 102.

As mentioned above, in some examples, instruction 126 may include a condition to indicate that alert generation module 160 should generate alert 162 when region 154 is of a particular size. Alert generation module 160 may compare a size of region 154 with a size threshold indicated by threshold 129 in order to determine whether to generate alert 162. In example 210, at operation 213, alert generation module 160 may determine that a size of region 154 is less than the size threshold indicated by threshold 129 and, in response, may request processor 122 to identify more faces that satisfy threshold 129. At operation 215, alert generation module 160 may determine that a size of region 154 is greater than the size threshold indicated by threshold 129 and, in response, may generate alert 162. In some examples, the size of region 154 being greater than the size threshold may indicate a potential presence of a threat in area 103 of venue 102.

As mentioned above, in some examples, instruction 126 may include a condition to indicate that alert generation module 160 should generate alert 162 when a rate of change of region 154 exceeds a particular rate. A rate of change of region 154 may include, for example, a change of a size of region 154, a change in a number of faces, a change of a shape of region 154, a change in an average sentiment value of faces in region 154, a change in spatial orientation (e.g. the direction in which faces are facing), a change in distance between faces, etc. In an example, alert generation module 160 may compare a size of region 154 at operation 213 with a size of region 154 at operation 215 to determine a rate of change of a size of region 154 relative to time. Threshold 129 may indicate a rate threshold, and alert generation module 160 may compare the rate of change of region 154 relative to time with the rate threshold indicated by threshold 129. In response to the rate of change of region 154 relative to time being greater than the rate threshold indicated by threshold 129, alert generation module 160 may generate alert 162. In some examples, the rate of change of region 154 being greater than the rate threshold may indicate a potential presence of a threat in area 103 of venue 102.

In some examples, instruction 126 may include a condition to indicate that alert generation module 160 should generate alert 162 based on a shape difference of region 154. Alert generation module 160 may compare a shape of region 154 at a first time, such as at operation 213, with a shape of region 154 at a second time, such as at operation 215, to determine a shape difference of region 154. Alert generation module 160 may further determine whether to generate alert 162 based on the shape difference of region 154. Focusing on a shape change of region 154 shown in example 210, a shape of region 154 may change in one or more directions, such as a direction 240 or a direction 242, from operation 213 to operation 215. Alert generation module 160 may determine the shape difference of region 154 based on the change of shape of region 154 from operation 213 to operation 215. Based on the shape difference and/or direction of changes of the shape of region 154, alert generation module 160 may generate alert 162 to indicate a direction and/or location of a threat within venue 102.

In some examples, instruction 126 may include a condition to indicate that alert generation module 160 should generate alert 162 based on a change in a number of faces that satisfies threshold 129 in region 154. In example 210, alert generation module 160 may determine that there is one face in region 154 at operation 212, and there are five faces in region 154 at operation 215. Alert generation module 160 may determine that there is an increase of four faces, or four hundred percent, from operation 213 to operation 215. Threshold 129 may indicate a percentage threshold related to a rate of change in a number of faces in region 154. Alert generation module 160 may compare four hundred percent with the percentage threshold indicated by threshold 129 in order to determine whether to generate alert 162. In response to four hundred percent being greater than the percentage threshold, alert generation module 160 may generate alert 162. In some examples, the change in the number of faces being greater than the percent threshold may indicate a presence of threat in area 103 of venue 102, and alert generation module 160 may generate alert 162.

In some examples, alert generation module 160 may be configured to determine that sentiment values 134 of faces in region data 152 persisted for a period of time. For example, threshold 129 may indicate a time threshold, and alert generation module 160 may determine that a period of time has lapsed between operation 212 and operation 215. Alert generation module 160 may compare the period of time with the time threshold indicated by threshold 129. In response to the period of time being greater than the time threshold, alert generation module 160 may request processor 122 to restart operation 211.

In some examples, instruction 126 may include a condition to indicate that alert generation module 160 should generate alert 162 based on a distance between identified regions in initial image 108. For example, processor 122 may identify a first region that includes faces corresponding to sentiment values 134 that satisfy threshold 129, and may identify a second region that includes faces corresponding to sentiment values 134 that satisfy threshold 129. Alert generation module 160 may determine a distance between the first region and the second region and, in response, may compare the distance with a distance threshold that may be indicated by threshold 129. If the distance satisfied the distance threshold, alert generation module 160 may generate alert 162. In some examples, the distance being greater than the distance threshold may indicate an absence of threat in area 103 of venue 102, and alert generation module 160 may not generate alert 162. In some examples, the distance being less than the distance threshold may indicate a presence of threat in area 103 of venue 102, and alert generation module 160 may generate alert 162.

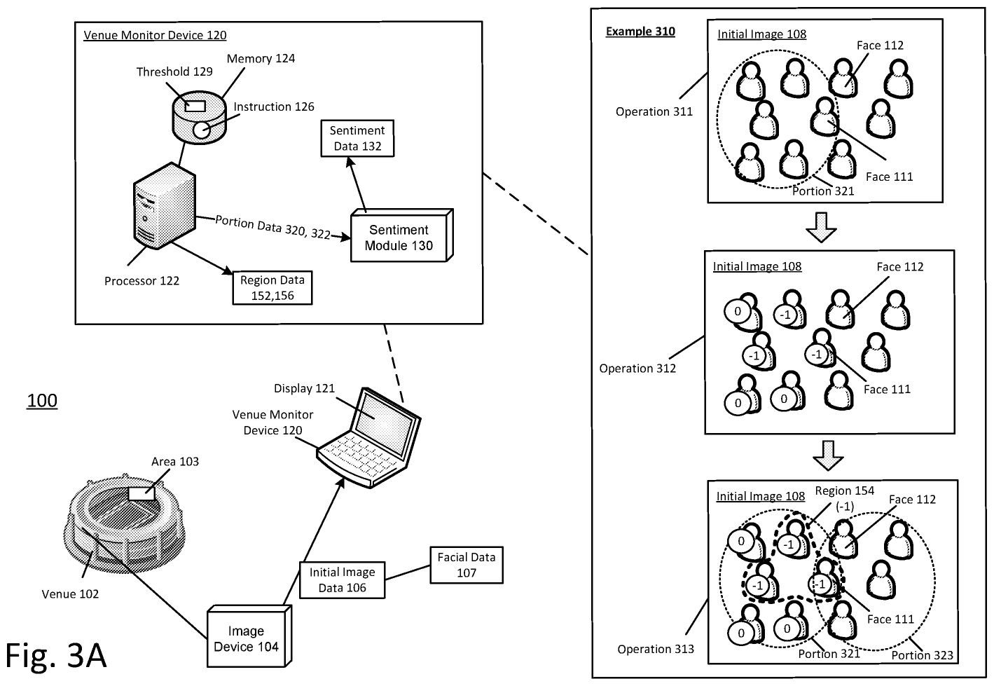

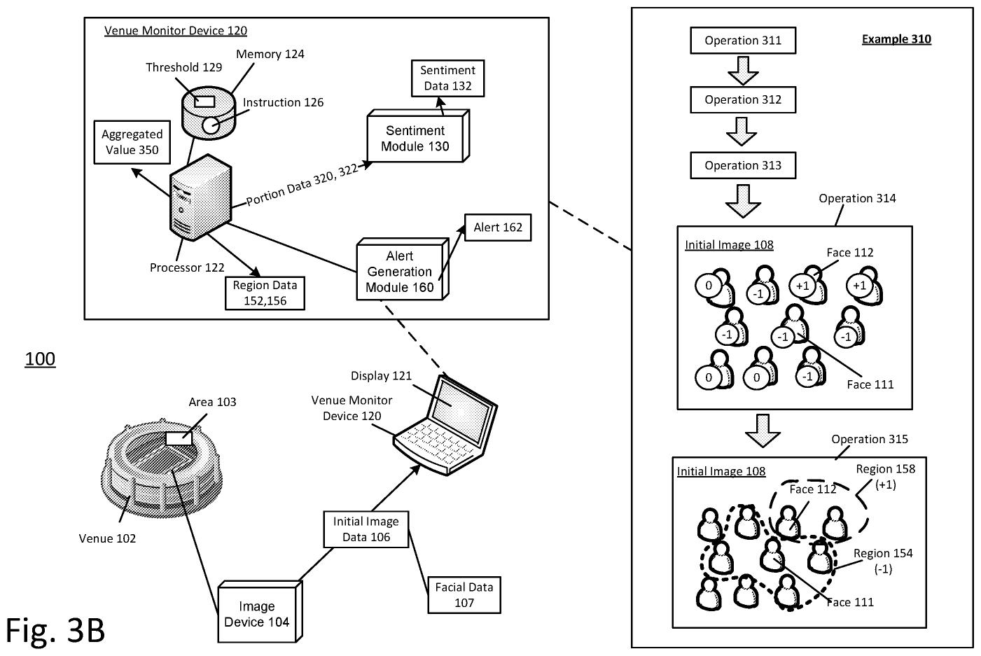

FIG. 3A illustrates example system 100 of FIG. 1 with additional detail relating to identification of region data, arranged in accordance with at least some embodiments described herein. FIG. 3A is substantially similar to system 100 of FIGS. 1-2C, with additional details. Those components in FIG. 3A that are labeled identically to components of FIGS. 1-2C will not be described again for the purposes of clarity.

In an example 310 shown in FIG. 3, venue monitor device 120 may identify region data 152 by performing operations 311, 312, 313, 314, 315. At operation 311, processor 122 of venue monitor device 120 may select portion data 320 from initial image data 106, where portion data 320 may correspond to a portion 321 in initial image 108. Portion 321 in initial image 108 may include one or more faces, such as face 111. Processor 122 may select portion data 320 in initial image data 106 based on instruction 126. For example, instruction 126 may include instruction for processor 122 to select a portion of initial image 108 that includes a particular number of faces, such as a range of four to eight faces. In response to selecting portion data 320 in initial image data 106, processor 122 may send portion data 320 to sentiment module 130.

Example 310 may continue from operation 311 to operation 312. At operation 312, sentiment module 130 may receive portion data 320 and, in response, may determine sentiment values 134 for respective faces in portion 321. Sentiment module 130 may apply instruction 126 on facial data 107 to determine sentiment value 134. Based on instruction 126, sentiment module 130 may determine that face 111 appear to show an angry sentiment, and determine a sentiment value 134 of “−1” for face 111. Sentiment module 130 may generate and/or update sentiment data 132 such that sentiment data 132 includes correspondence between face 111 and a sentiment value 134 of “−1”. Upon a completion of determining sentiment value 134 for faces in portion 321, sentiment module 130 may send a completion signal to processor 122 to notify processor 122 that determination of sentiment values 134 of faces in portion 321 is completed. Sentiment module 130 may store sentiment data 132 in memory 124.

Example 310 may continue from operation 312 to operation 313. At operation 313, processor 122 may retrieve sentiment data 132 from memory 124 or may receive sentiment data 132 from sentiment module 130. Processor 122 may compare sentiment values 134 in sentiment data 132 with threshold 129 to identify one or more faces. In example 310, threshold 129 may be “0”, and instruction 126 may indicate that a particular sentiment value 134 may satisfy threshold 129 if the particular sentiment value 134 is less than threshold 129. Upon a comparison of sentiment value 134 of face 111 with threshold 129, processor 122 may identify face 111 in response to sentiment value 134 “−1” of face 111 being less than threshold 129 of “0”. Upon a completion of identifying faces in sentiment data 132, processor 122 may identify region data 152 in initial image data 106, where region data 152 may correspond to region 154 in initial image 108. In response to identifying region data 152, processor 122 may send region data 152 to alert generation module 160.

In some examples, a user may identify a relatively smaller region with sentiment values that satisfy the threshold and may expand a size of the smaller region to see if the expanded region includes an expanded set of sentiment values that satisfy the threshold. For example, continuing operation 313, alert generation module 160 may receive region data 152 and, in response, may determine whether to generate alert 162 based on one or more conditions indicated by instruction 126. Instruction 126 may indicate that alert generation module 160 should generate alert 162 when five faces corresponding to sentiment values 134 that satisfies threshold 129 are present in region 154. Since region 154 includes three faces that correspond to a sentiment value 134 that satisfies threshold 129, alert generation module 160 may not generate alert 162. Alert generation module 160 may send a signal to processor 122 to request processor 122 to identify more faces and/or additional region data in initial image data 106. Instruction 126 may further include instructions for processor 122 to identify portion data in addition to portion data 320 in order to identify additional faces in initial image 108. Based on instruction 126, processor 122 may identify portion data 322 associated with portion 323, where portion 323 may be substantially the same size as portion 321, and may overlap with at least a part of portion 321. For example, face 111 may be a part of portion 321, and may be a part of portion 323. In response to identifying portion data 322, processor 122 may send portion data 322 to expression module 130 to determine expression values 134 of faces in portion data 322.

FIG. 3B illustrates example system 100 of FIG. 1 with additional detail relating to identification of region data, arranged in accordance with at least some embodiments described herein. FIG. 3B is substantially similar to system 100 of FIGS. 1-3A, with additional details. Those components in FIG. 3B that are labeled identically to components of FIGS. 1-3A will not be described again for the purposes of clarity.

Example 310 may continue from operation 313 to operation 314. At operation 314, sentiment module 130 may receive portion data 322 and, in response, may determine sentiment values 134 for respective faces in portion 323. Sentiment module 130 may apply instruction 126 on facial data 107 that correspond to faces in portion 323 to determine sentiment values 134. Based on instruction 126, sentiment module 130 may determine that face 112 appears to show a happy sentiment, and determine a sentiment value 134 of “+1” for face 112. Sentiment module 130 may generate and/or update sentiment data 132 such that sentiment data 132 includes correspondence between face 112 and a sentiment value 134 of “+1”. Sentiment module 130 may continue to determine sentiment values 134 for faces within portion 323 and update sentiment data 132. Upon a completion of determining sentiment value 134 for faces in portion 323, sentiment module 130 may send a completion signal to processor 122 to notify processor 122 that determination of sentiment values 134 of faces in portion 323 is completed. Sentiment module 130 may update sentiment data 132 and may store sentiment data 132 in memory 124.

Example 310 may continue from operation 314 to operation 315. At operation 315, processor 122 may retrieve sentiment data 132 from memory 124 or may receive sentiment data 132 from sentiment module 130. Processor 122 may compare sentiment values 134 in sentiment data 132 with threshold 129 to identify one or more faces. Processor 122 may identify one or more faces that correspond to sentiment values 134 that are less than “0”. Upon a completion of identifying faces in sentiment data 132, processor 122 may identify region data 152 in initial image data 106. In response to identifying region data 152, processor 122 may send region data 152 to alert generation module 160. Alert generation module 160 may receive region data 152 and, in response, may determine whether to generate alert 162 based on one or more conditions indicated by instruction 126. Instruction 126 may indicate that alert generation module 160 should generate alert 162 when five faces corresponding to sentiment values 134 that satisfy threshold 129 are present in region 154. Since region 154 includes five faces that corresponds to sentiment values 134 that satisfy threshold 129, alert generation module 160 may generate alert 162.

In some examples, processor 122 may determine respective aggregated value 350 that corresponds to portions of initial image 108, such as portions 321, 323. In some examples, aggregated value 350 may be an average of sentiment values 134 of faces in portions 321, 323. For example, aggregated value 350 corresponding to portion 321 may be “−0.5” (average of 0, 0, 0, −1, −1, −1). Aggregated value 350 corresponding to portion 323 may be “−0.2” (average of −1, −1, −1, +1, +1). Processor 122 may compare respective aggregated value 350 with threshold 129. In an example where threshold 129 is “−0.3”, processor 122 may determine that at least some faces in portion 321 should be a part of region 154, and portion 323 should be excluded from region 154 in order to identify region data 152. In some examples, aggregated value 350 may be a sum, a weighted average, etc., of sentiment values 134 corresponding to portions 321, 323. In some examples, aggregated value 350 may be a multiple of faces times average of sentiment values 134, or may be a change in an average of sentiment values 134.

In some examples, alert generation module 160 may compare aggregated value 350 of region 154 with an aggregated value 350 of a different region to determine whether to generate alert 162. For example, if a difference between aggregated value 350 of region 154 and aggregated value of a different region exceeds threshold 129, then alert generation module 160 may generate alert 162. In some examples, a user of venue monitor device 120 may adjust threshold 129 based on the difference between aggregated value 350 of region 154 and one or more different regions in initial image 108. Initial image 108 may include ten different regions (including region 154), where each region corresponds to a respective aggregated value 350. Instruction 126 may indicate that if more than seventy percent of the ten different regions correspond to an aggregated value 350 that satisfies threshold 129, then adjust threshold 129. For example, if eight out of the ten different regions correspond to an aggregated value 350 that is less than threshold 129 of “−0.8”, then the user of venue monitor device 120 may adjust threshold 129 to “−1.5”. By adjusting threshold 129, venue monitor device 120 may identify less than eight regions out of the ten different regions in order to identify a more precise region of a potential threat in area 103 of venue 102.

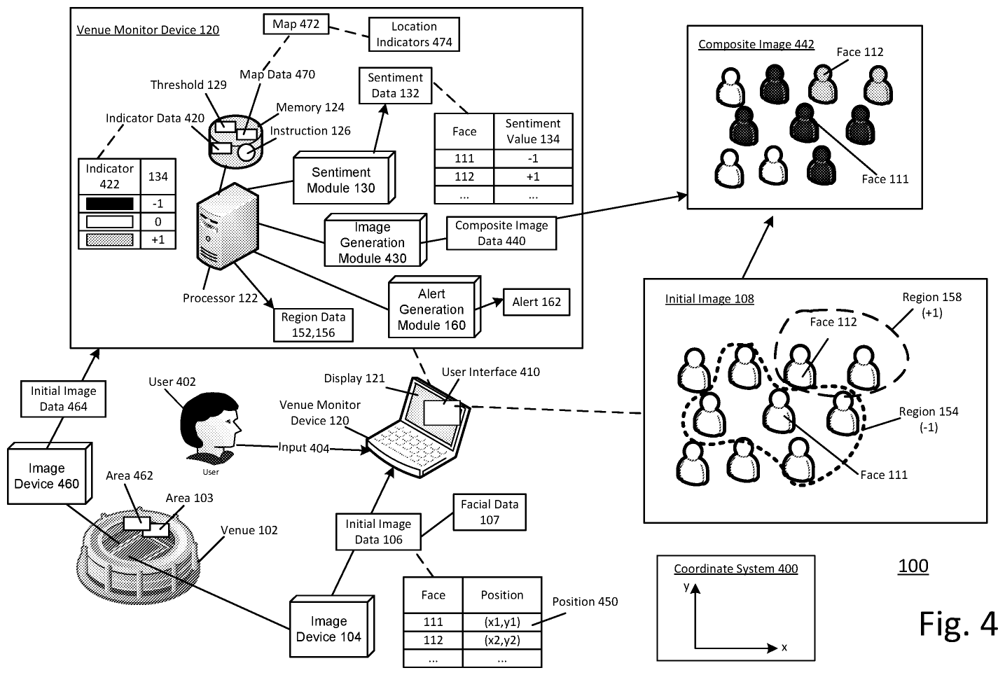

FIG. 4 illustrates example system 100 of FIG. 1 with additional detail relating to a user interface, arranged in accordance with at least some embodiments described herein. FIG. 4 is substantially similar to system 100 of FIGS. 1-3B, with additional details. Those components in FIG. 4 that are labeled identically to components of FIGS. 1-3B will not be described again for the purposes of clarity.

In an example, processor 122 may be configured to output a user interface 410 on display 121 of venue monitor device 120. User interface 410 may show initial image 108 such that a user 402 of venue monitor device 120 may view initial image 108. In some examples, processor 122 may output regions 154, 158 on user interface 410 such that user 402 may view regions 154, 158. In some examples, user 402 may be a personnel associated with venue 102.

Venue monitor device 120 may further include an image generation module 430, where image generation module 430 may be configured to be in communication with processor 122, memory 124, sentiment module 130, and/or alert generation module 160. Image generation module 430 may be configured to generate composite image data 440, where composite image data 440 may be associated with a composite image 442. Composite image data 440, when rendered on display 121, may produce composite image 442 on display 121. In an example, image generation module 430 may receive sentiment data 132 and/or initial image data 106. In response to receiving sentiment data 132 and/or initial image data 106, image generation module 430 may generate composite image data 150 based on sentiment data 132, initial image data 106, and indicator data 420. Indicator data 420 may be stored in memory 124 and may be a part of instruction 126. Indicator data 420 may include a set of rules to associated a set of defined sentiment values 134, such as “−1”, “0”, “+1”, with indicators 422. Indicators 422 may include colors, shadings, patterns, numbers, etc. For example, indicator data 420 may include a set of rules indicating that sentiment value “−1” is associated with a color red, sentiment value “0” is associated with a color blue, sentiment value “+1” is associated with a color yellow, etc. Image generation module 430 may map sentiment data 132 to indicator data 420 to generate composite image data 440. Composite image data 440 may include correspondences of faces to indicators 422. For example, composite image data 440 may include a correspondence between face 111 and indicator 422, where indicator 422 may correspond to sentiment value 134 of “4”. Image generation module 430 may send composite image data 150 to processor 122 such that composite image 442 may be shown on user interface 410.

In an example, user 402 may view composite image 442 with use of user interface 410 displayed on display 121. User 402 may wish to identify more faces that correspond to sentiment values 134 satisfying threshold 129. User 402 may provide an input 404, such as by using a computer mouse or a keyboard of venue monitor device 120, to request venue monitor device 120 to identify more faces. Processor 122 may receive input 404 and, in response, may execute instruction 126 to identify additional faces that correspond to sentiment values 134 satisfying threshold 129. In some examples, alert generation module 160 may send alert 162 to image generation module 430. Image generation module 430 may receive alert 162 and in response, may output composite image 442 on display 121 in order to display alert 162 as region 154 with corresponding indicators 422. For example, in response to receiving alert 162, image generation module 430 may display composite image 442, where composite image 442 may include faces of region 154 highlighted with a particular color according to indicator data 420. As a result of displaying composite image 442 with faces of region 154 highlighted, user 402 may view alert 162 on display 121.

In some examples, image device 104 may be configured to generate initial image data 464 corresponding to an area 462 of venue 102, such as by panning a field of view of image device 104 to area 462. Processor 122 may request image device 104 to send initial image data 464 to venue monitor device 120, where initial image data 464 may be different from initial image data 106, in order to identify additional faces. In some examples, an image device 460, different from image device 104, may be configured to generate initial image data 464 corresponding to area 462 of venue 102. Processor 122 may request image device 460 to send initial image data 464 to venue monitor device 120 in order to identify additional faces.

In some examples, instruction 126 may include a condition to indicate that alert generation module 160 should generate alert 162 based on distances between a first identified region in initial image 108 and a second identified region in an image associated with initial image data 464. In some examples, alert generation module 160 may identify respective centers of the first and second identified regions, and determine a distance between the respective centers. In some examples, alert generation module 160 may compare respective distances between one or more edges of each of the first and second identified regions, and may identify a first edge of the first identified region and a second edge of the second identified region that are separated by a shortest distance. In some examples, processor 122 may be configured to determine the distance between the first and second identified regions and, in response, may send the determined distance to alert generation module 160. In some examples, processor 122 may be configured to determine a rate of change of distances between centers and/or edges of the first and second regions. A change in distances between the first and second regions may indicate whether faces that satisfy threshold 129 from each region are about to meet with each other, where a meeting of faces that satisfy threshold 129 may indicate a potential threat in area 103 of venue 102. Processor 122 may identify a first region in initial image 108 that includes faces corresponding to sentiment values 134 that satisfies threshold 129, and may identify a second region in the image associated with initial image data 464 that includes faces corresponding to sentiment values 134 that satisfies threshold 129. Alert generation module 160 may determine a distance between the first region and the second region and, in response, may compare the distance with a distance threshold that may be indicated by threshold 129. If the distance satisfied the distance threshold, alert generation module 160 may generate alert 162.

In some examples, user 402 may wish to modify threshold 129 after viewing composite image 442 in user interface 410. User 402 may provide an input 404 to venue monitor device 120 to request a modification of threshold 129. Processor 122 may receive input 404 and, in response, may modify threshold 129 according to input 404. In some examples, user 402 may wish to modify conditions indicated by instruction 126 after viewing composite image 442 in user interface 410. For example, user 402 may wish to identify faces that correspond to sentiment values 134 that are greater than threshold 129 instead of less than threshold 129. User 402 may provide an input 404 to venue monitor device 120 to request a modification of conditions indicated by instruction 126. Processor 122 may receive input 404 and, in response, may modify conditions indicated by instruction 126 according to input 404. In some examples, user 402 may wish to modify threshold 129 and/or instruction 126 in order to reduce a sensitivity associated with generation of alert 162. For example, user 402 may consider generating alert 162 in response to identifying five faces with sentiment value “−1” as being too sensitive, and may wish to modify instruction 126 to generate alert 162 in response to identifying twenty faces with sentiment value “−1”.

As mentioned above, alert 162 may be an alert effective to indicate a potential presence of a threat associated with venue 102. In response to generating alert 162, alert generation module 160 may associate alert 162 with a location within venue 102. In an example, region 154 may be centered at a position of face 111 in initial image 108. Initial image data 106 may include positions of one or more faces in initial image 108, where positions of faces may be represented as coordinates in a coordinate system 400. Coordinate system 400 may be a two-dimensional Cartesian coordinate system. For example, initial image data 106 may indicate that face 111 is located at position 450, or (x1, y1), in initial image 108. Alert generation module 160 may determine that region 154 is centered at position 450 based on region 154 being centered at position 450 of face 111. Alert generation module 160 may associate alert 162 with position 450 and may send alert 162 and position 450 to processor 122.

Processor 122 may receive alert 162 and position 450 and, in response, may transform position 450 according to map data 470 of venue 102. Map data 470 of venue 102 may be associated with a map 472 of venue 102, where map 472 of venue 102 may include location indicators 474 such as coordinates, seat sections, rows of seats, etc. For example, if venue 102 is a stadium, location indicators 474 may include section number, row number, seat number, etc. Processor 122 may be configured to transform position 450 into a format of location indicators 474 in map data 470. For example, processor 122 may transform position 450 into a particular section, row, and seat number of venue 102. In another example, location indicators 474 in map data 470 may be coordinates of different coordinate systems such as polar, cylindrical, etc. In response to generating alert 162, venue monitor device 120 may send alert 162, and corresponding location in venue 102, to entities such as security, law enforcement, government agencies, etc., to notify the entities of any potential threat and corresponding locations in venue 102.

A system in accordance with the present disclosure may benefit security in public locations including large crowds such as stadiums, arenas, shopping malls, streets, a protest, etc. A system may provide alerts to notify authorities of any potential threat due to detected negative emotions or sentiments in a crowd. The system may further provide a location of the potential threat, as well as a direction of spread of the potential threat. By notifying potential threat to authorities, the authorities may have ample time to prepare to handle potential threats in a public location.

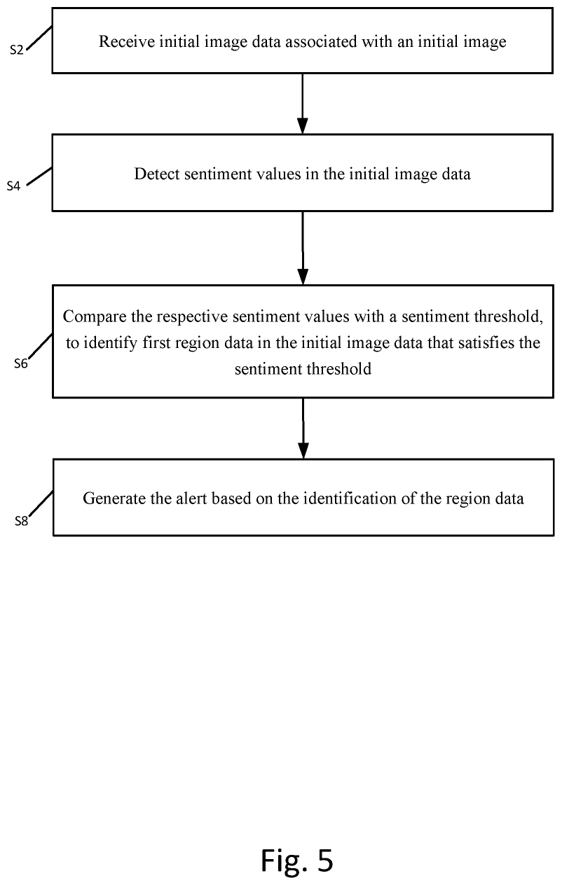

FIG. 5 illustrates a flow diagram for an example process to implement venue monitoring through sentiment analysis, arranged in accordance with at least some embodiments presented herein. The process in FIG. 5 could be implemented using, for example, system 100 discussed above. An example process may include one or more operations, actions, or functions as illustrated by one or more of blocks S2, S4, S6, S8, and/or S10. Although illustrated as discrete blocks, various blocks may be divided into additional blocks, combined into fewer blocks, or eliminated, depending on the desired implementation.

Processing may begin at block S2, “Receive initial image data associated with an initial image”. At block S2, a device may receive initial image data associated with an initial image. In some examples, the device may receive the initial image data from one or more image devices located in a venue. The initial image data may correspond to an area of the venue.

Processing may continue from block S2 to block S4, “Detect sentiment values in the initial image data”. At block S4, the device may detect sentiment values in the initial image. The sentiment values may correspond to two or more locations in the initial image. Each location may correspond to a person present. In some examples, determining the respective sentiment values may include applying a voice classification technique to acoustic data that corresponds to the sentiment values. In some examples, determining the respective sentiment values may include applying a motion detection technique to motion data that corresponds to the sentiment values.

Processing may continue from block S4 to block S6, “Compare the respective sentiment values with a sentiment threshold, to identify first region data in the initial image data that satisfies the sentiment threshold”. At block S6, the device may compare the respective sentiment values with a sentiment threshold. Based on the comparison, the device may identify first region data in the initial image data, where the first region data may correspond to a first region in the initial image. The first region data may include sentiment data that corresponds to sentiment values that satisfies the sentiment threshold.

Processing may continue from block S6 to block S8, “Generate the alert based on the identification of the region data”. At block S10, the device may generate an alert based on the identification of the first region data. In some examples, generation of the alert may be based on a size of the first region data. In some examples, generation of the alert may be based on a rate of change of a size of the first region data. In some examples, generation of the alert may be based on a shape of the first region data.

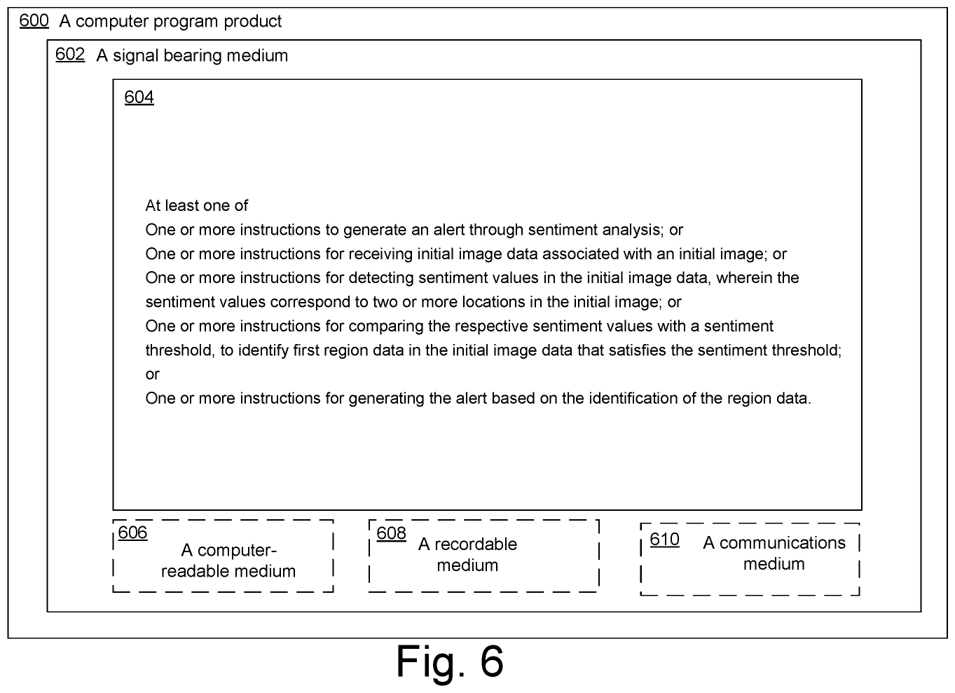

FIG. 6 illustrates an example computer program product 600 that can be utilized to implement venue monitoring through sentiment analysis, arranged in accordance with at least some embodiments presented herein. Computer program product 600 may include a signal bearing medium 602. Signal bearing medium 602 may include one or more instructions 604 that, when executed by, for example, a processor, may provide the functionality described above with respect to FIGS. 1-5. Thus, for example, referring to system 100, venue monitor device 120 may undertake one or more of the blocks shown in FIG. 6 in response to instructions 604 conveyed to the system 100 by signal bearing medium 602.

In some implementations, signal bearing medium 602 may encompass a computer-readable medium 606, such as, but not limited to, a hard disk drive, a Compact Disc (CD), a Digital Versatile Disc (DVD), a digital tape, memory, etc. In some implementations, signal bearing medium 602 may encompass a recordable medium 608, such as, but not limited to, memory, read/write (R/W) CDs, R/W DVDs, etc. In some implementations, signal bearing medium 602 may encompass a communications medium 610, such as, but not limited to, a digital and/or an analog communication medium (e.g., a fiber optic cable, a waveguide, a wired communications link, a wireless communication link, etc.). Thus, for example, computer program product 600 may be conveyed to one or more modules of the system 100 by an RF signal bearing medium 602, where the signal bearing medium 602 is conveyed by a wireless communications medium 610 (e.g., a wireless communications medium conforming with the IEEE 802.11 standard).

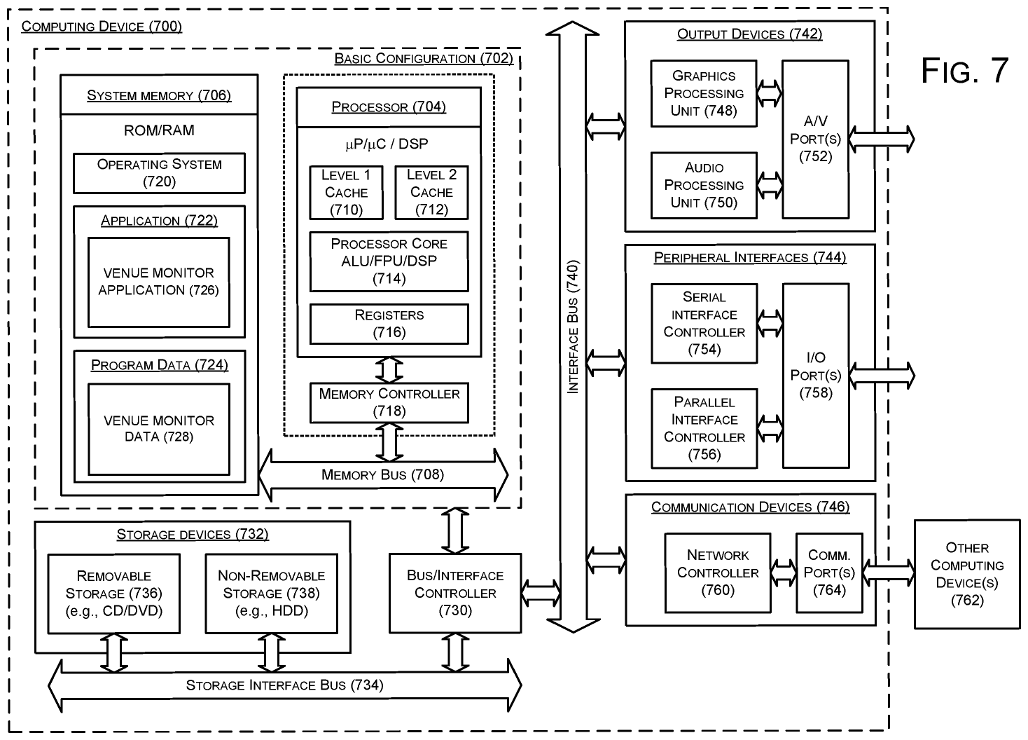

FIG. 7 is a block diagram illustrating an example computing device 700 that is arranged to implement venue monitoring through sentiment analysis, arranged in accordance with at least some embodiments presented herein. In a very basic configuration 702, computing device 700 typically includes one or more processors 704 and a system memory 706. A memory bus 708 may be used for communicating between processor 704 and system memory 706.

Depending on the desired configuration, processor 704 may be of any type including but not limited to a microprocessor (μP), a microcontroller (μC), a digital signal processor (DSP), or any combination thereof. Processor 704 may include one more levels of caching, such as a level one cache 710 and a level two cache 712, a processor core 714, and registers 716. An example processor core 714 may include an arithmetic logic unit (ALU), a floating point unit (FPU), a digital signal processing core (DSP Core), or any combination thereof. An example memory controller 718 may also be used with processor 704, or in some implementations memory controller 718 may be an internal part of processor 704.

Depending on the desired configuration, system memory 706 may be of any type including but not limited to volatile memory (such as RAM), non-volatile memory (such as ROM, flash memory, etc.) or any combination thereof. System memory 706 may include an operating system 720, one or more applications 722, and program data 724. Application 722 may include venue monitor instructions 726 that is arranged to perform the functions as described herein including those described previously with respect to FIGS. 1-6. Program data 724 may include venue monitor data 728 that may be useful for alternative training distribution based on density modification as is described herein. In some embodiments, application 722 may be arranged to operate with program data 724 on operating system 720 such that venue monitoring through sentiment analysis may be provided. This described basic configuration 702 is illustrated in FIG. 7 by those components within the inner dashed line.

Computing device 700 may have additional features or functionality, and additional interfaces to facilitate communications between basic configuration 702 and any required devices and interfaces. For example, a bus/interface controller 730 may be used to facilitate communications between basic configuration 702 and one or more data storage devices 732 via a storage interface bus 734. Data storage devices 732 may be removable storage devices 736, non-removable storage devices 738, or a combination thereof. Examples of removable storage and non-removable storage devices include magnetic disk devices such as flexible disk drives and hard-disk drives (HDD), optical disk drives such as compact disc (CD) drives or digital versatile disc (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 706, removable storage devices 736 and non-removable storage devices 738 are examples of computer storage media. Computer storage media includes, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other medium which may be used to store the desired information and which may be accessed by computing device 700. Any such computer storage media may be part of computing device 700.

Computing device 700 may also include an interface bus 740 for facilitating communication from various interface devices (e.g., output devices 742, peripheral interfaces 744, and communication devices 746) to basic configuration 702 via bus/interface controller 730. Example output devices 742 include a graphics processing unit 748 and an audio processing unit 750, which may be configured to communicate to various external devices such as a display or speakers via one or more A/V ports 752. Example peripheral interfaces 744 include a serial interface controller 754 or a parallel interface controller 756, which may be configured to communicate with external devices such as input devices (e.g., keyboard, mouse, pen, voice input device, touch input device, etc.) or other peripheral devices (e.g., printer, scanner, etc.) via one or more I/O ports 758. An example communication device 746 includes a network controller 760, which may be arranged to facilitate communications with one or more other computing devices 762 over a network communication link via one or more communication ports 764.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 700 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 700 may also be implemented as a personal computer including both laptop computer and non-laptop computer configurations.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method to generate an alert through sentiment analysis, the method comprising, by a device:
receiving initial image data associated with an initial image;
detecting sentiment values in the initial image data, wherein the sentiment values correspond to two or more locations in the initial image;
comparing respective sentiment values with a sentiment threshold to identify region data in the initial image data that satisfies the sentiment threshold; and
generating the alert based on the identification of the region data.

2. The method of claim 1, further comprising applying indicator data to the respective sentiment values to produce composite image data associated with a composite image, wherein the indicator data includes associations of a set of indicators to a set of defined sentiment values, and the composite image includes the initial image and the set of indicators.

3. The method of claim 2, further comprising displaying the composite image, wherein the composite image includes a region with corresponding indicators, the region is associated with the region data, a display of the composite image includes a display of the region, and the display of the region is effective to display the alert.

4. The method of claim 1, wherein comparing the respective sentiment values with the sentiment threshold to identify the region data includes:
identifying respective sentiment values that are less than the sentiment threshold; and
identifying respective sentiment values that corresponds to the identified respective sentiment values.

5. The method of claim 1, further comprising:
determining a size corresponding to the region data; and
determining the size is greater than a size threshold, wherein generating the alert is further based on the determination that the size is greater than the size threshold.

6. The method of claim 5, prior the generating the alert, the method further comprising:
determining a rate of change of the size; and
determining that the rate of change is greater than a rate threshold, wherein generating the alert is further based on the determination that the rate of change is greater than the rate threshold.

7. The method of claim 1, further comprising:
determining a first shape that corresponds to the region data at a first time;
determining a second shape that corresponds to the region data at a second time; and
determining a shape difference between the first shape and the second shape, wherein generating the alert is further based on the shape difference between the first shape and the second shape.

8. The method of claim 1, wherein the region data is first region data and the method further comprising, prior to generating the alert:
identifying second region data in the initial image data, wherein the second region data satisfies the sentiment threshold; and
determining a distance between the first region data and the second region data, wherein generating the alert is further based on the distance.

9. The method of claim 1, wherein:
the initial image data is first initial image data;
the region data is first region data;
the initial image is a first initial image;
the respective sentiment values are first respective sentiment values, and the method further comprises, prior to generating the alert:
determining that the first respective sentiment values of the first region data persist for a period of time;
after a lapse of the period of time, receiving second initial image data associated with a second initial image;
detecting second respective sentiment values in the second initial image data; and
comparing the second respective sentiment values with the sentiment threshold to identify second region data that satisfies the sentiment threshold, wherein generating the alert is further based on the identification of the second region data.

10. The method of claim 1, wherein detecting the sentiment values includes:
applying a facial expression technique to the initial image data; and
detecting the respective sentiment values based on the application of the facial expression technique to the initial image data.

11. The method of claim 1, further comprising, prior to detecting the sentiment values, receiving acoustic data that corresponds to the sentiment values;
wherein detecting the sentiment values includes:
applying a voice classification technique to the acoustic data; and
detecting the sentiment values based on the application of the voice classification technique to the acoustic data.

12. The method of claim 1, further comprising, prior to detecting the respective sentiment values, receiving motion data that corresponds to the sentiment values;
wherein detecting the respective sentiment values includes:
applying a motion detection technique on the motion data; and
detecting the respective sentiment values based on the application of the motion detection technique on the motion data.

13. A system effective to generate an alert through sentiment analysis, the system comprising:
an image device effective to capture initial image data;
a processor configured to be in communication with the image device;
a sentiment module configured to be in communication with the processor;
an alert generation module configured to be in communication with the processor and the sentiment module;
the processor being configured to:
receive initial image data from the image device, wherein the initial image data is associated with an initial image; and
send the initial image data to the sentiment module;
the sentiment module being configured to:
detect sentiment values in the initial image data, wherein the sentiment values correspond to two or more locations in the initial image; and
the alert generation module being configured to:
compare respective sentiment values with a sentiment threshold to identify region data in the initial image data that satisfies the sentiment threshold; and
generate the alert based on the identification of the region data.

14. The system of claim 13, wherein the alert generation module is further configured to:
determine a size that corresponds to the region data; and
determine the size is greater than a size threshold, wherein generation of the alert is further based on the determination that the size is greater than the size threshold.

15. The system of claim 14, wherein the alert generation module is further configured to:
determine a rate of change of the size; and
determine that the rate of change is greater than a rate threshold, wherein generation of the alert is further based on the determination that the rate of change is greater than the rate threshold.

16. The system of claim 13, wherein the alert generation module is further configured to:
determine a first shape that corresponds to the region data at a first time;
determine a second shape that corresponds to the region data at a second time; and
determine a shape difference between the first shape and the second shape, wherein generation of the alert is further based on the shape difference between the first shape and the second shape.

17. The system of claim 13, wherein the region data is first region data and the alert generation module is further configured to:
identify second region data in the initial image data, wherein the second region data satisfies the sentiment threshold; and
determine a distance between the first region data and the second region data, wherein generation of the alert is further based on the distance.

18. The system of claim 13, wherein:
the image device is a first image device;
the initial image data is first initial image data; and
the region data is first region data, and
wherein the processor is further configured to:
receive second initial image data from a second image device, wherein the second image device is configured to be in communication with the processor, and the second initial image data is associated with a second initial image; and
send the second initial image data to the sentiment module;
wherein the sentiment module is further configured to determine second respective sentiment values;
wherein the alert generation module is further configured to:
identify second region data in the second initial image data, wherein the second region data satisfies the sentiment threshold;
determine a distance between the first region data and the second region data; and
generate the alert based on the distance.

19. The system of claim 13, wherein:
the initial image data is first initial image data;
the initial image is a first initial image;
the region data is first region data; and
the respective sentiment values are first respective sentiment values, and
wherein the processor is further configured to:
determine that the first respective sentiment values of the first region data persist for a period of time;
after a lapse of the period of time, receive second initial image data associated with a second initial image;
send the second initial image data to the sentiment module;
wherein the sentiment module is further configured to determine second respective sentiment values for a second region data; and
wherein the alert generation module is further configured to identify second region data in the second initial image data, wherein the second region data satisfies the sentiment threshold, and wherein generation of the alert is further based on the identification of the second region data.

20. A monitor device effective to generate an alert through sentiment analysis, the monitor device comprising:
a memory configured to store an instruction and a sentiment threshold;
a sentiment module configured to be in communication with the memory;
an alert generation module configured to be in communication with the sentiment module and the memory;
the sentiment module being configured to:
receive initial image data associated with an initial image;
detect sentiment values in the initial image data, wherein the sentiment values correspond to two or more locations in the initial image; and
store the respective sentiment values in the memory;
the alert generation module being configured to:
compare respective sentiment values with the sentiment threshold to identify region data in the initial image data that satisfies the sentiment threshold; and
generate the alert based on the identification of the first region data.

21. The monitor device of claim 20, further comprising an image generation module configured to be in communication with the memory, the sentiment module, and the alert generation module, wherein:
the memory is further configured to store indicator data that includes associations of a set of indicators to a set of defined sentiment values; and
the image generation module is configured to apply the indicator data to the respective sentiment values to produce composite image data associated with a composite image, wherein the composite image includes the initial image and the set of indicators.

22. The method of claim 1, further comprising:
providing the alert to an image generation module of the device to generate a composite image associated with the alert; and
displaying the composite image associated with the alert on a display of the device such that a user is provided the alert via the display.

23. The system of claim 13, further comprising:
an image generation module that is configured to be in communication with the alert generation module; and
a display that is configured to be in communication with the image generation module;
wherein:
the alert generation module is further configured to send the alert to the image generation module;
the image generation module is configured to generate a composite image associated with the alert and send the composite image to the display; and
the display is configured to provide the composite image associated with the alert to a user of the system.

24. The monitor device of claim 20, further comprising:
an image generation module that is configured to be in communication with the alert generation module; and
a display that is configured to be in communication with the image generation module;
wherein:
the alert generation module is further configured to send the alert to the image generation module;
the image generation module is configured to generate a composite image associated with the alert and send the composite image to the display; and
the display is configured to provide the composite image associated with the alert to a user of the monitor device.
